(19) United States
(12) Patent Application Publication
(10) Pub. No.: US 2014/0310150 A1
(43) Pub. Date: Oct. 16, 2014

(54) SYSTEMS AND METHODS FOR ESTABLISHING OR IMPROVING CREDIT WORTHINESS

(71) Applicants: Darin G. Petty, Riverton, UT (US); Christopher Scanlon, Lehi, UT (US)

(72) Inventors: Darin G. Petty, Riverton, UT (US); Christopher Scanlon, Lehi, UT (US)

(21) Appl. No.: 13/862,823

(22) Filed: Apr. 15, 2013

(51) Int. Cl. G06Q 40/00

(52) U.S. Cl. CPC G06Q 40/025
USPC 705/38

(57) ABSTRACT

Systems and methods for establishing or improving a consumer's credit worthiness are disclosed. A system for establishing or improving a consumer's credit worthiness may include three or more levels, in which a consumer is provided with increasing financial responsibilities. In a first level, a consumer may be provided with one or more financial tools that enable the consumer to participate in basic financial transactions; for example, transactions involving a general purpose reloadable debit card. In a second level, the consumer may be provided with one or more financial tools that enable him or her to participate in intermediate financial transactions; for example, transactions involving a secured credit card. In a third level, the consumer may be provided with one or more financial tools that facilitate advanced financial transactions; for example, transactions involving an unsecured credit card. An administrator may collect information about a consumer's financial transactions, evaluate the consumer's credit worthiness and manage the types of financial transactions in which the consumer is permitted to participate.

### TECHNICAL FIELD

This disclosure relates generally to systems and methods for establishing or improving a consumer's credit worthiness. More specifically, this disclosure relates to structured systems and methods for establishing or improving a consumer's credit worthiness based on spending and payment behaviors in a number of different contexts.

### RELATED ART

A consumer's credit worthiness is typically measured in terms of a credit rating or credit score (e.g., a Fair Isaac Corporation, or FICO, score; etc.) from one of three major credit bureaus. Conventionally, a consumer could establish his or her credit worthiness by opening a credit account, borrowing money against the debt account, and making timely payments against the debt accrued in that credit account. Typically, a variety of different credit accounts have been useful for establishing credit worthiness, including, but not limited to, monthly payment accounts (utility accounts, mobile telephone accounts, etc.), revolving credit accounts (e.g., credit card accounts, installment payment accounts, etc.), car loans, mortgages, and the like.

If a consumer uses his or her credit accounts and always makes timely payments, his or her credit worthiness typically improves. As a consumer's credit worthiness improves, so does his or her ability to borrow money. Lenders are usually more willing to lend money to a consumer with a good credit history. Often times, a consumer's credit history also affects the amount of money that consumer may borrow. Conversely, if a consumer occasionally misses payments on one or more debt accounts, his or her credit worthiness and credit score may decrease, diminishing that consumer's ability to borrow money and, if the consumer can find a willing lender, the amount of money that the consumer can borrow.

The credit worthiness of many consumers is undesirably low. Some consumers, particularly young adults, simply have no credit history for a credit bureau or lender to assess; their lack of experience equates to low credit worthiness. Other consumers who have low credit worthiness suffer from the misfortune of financial difficulties (e.g., an unexpected decrease in income, termination of income, etc.). Other consumers manage their finances poorly.

When a consumer applies for credit from a potential lender, that lender will typically consider the consumer's credit score and few other items of financial information (e.g., income, monthly payment obligations, etc.). Lenders (especially credit card companies) will usually not consider a consumer's credit (i.e., use and payment) behaviors until the lender makes a determination about increasing the amount of credit that will be provided to that consumer.

### SUMMARY

Systems and methods for enabling a consumer to establish or improve his or her credit worthiness are disclosed. The disclosed systems and methods provide consumers with the ability to access tools that enable consumers to proactively establish or improve their credit worthiness. In such a system and method, the consumer's credit behaviors may be considered when deciding whether or not credit will be extended to that consumer. As a consumer exhibits sound financial behavior, and continues to exhibit sound financial behavior over extended periods of time, he or she may access additional tools for establishing or improving his or her credit worthiness.

In some embodiments, a system that incorporates teachings of this disclosure may include three or more components, or levels. In a first level, a consumer may be provided with tools (e.g., a debit card attached to a bank account, a prepaid debit card, etc.) that enable that consumer to establish certain financial behaviors (e.g., spending behaviors, payment/account replenishment behaviors, etc.). Those financial behaviors may serve as the basis for credit behaviors that are to be assessed by a lender at a later time, when the lender will make a decision on whether or not it will extend credit to the consumer. Thus, in the first level, a consumer may uses tools that will enable the consumer to establish financial behaviors. If the consumer has used the tools responsibly, he or she will be able to establish a basic level of credit worthiness. Accordingly, the first level may be characterized as a “preparatory level,” in which the consumer uses tools and establishes financial behaviors that may be indicative of a basic level of credit worthiness.

A second level of a system for establishing or improving a consumer's credit worthiness provides a consumer with at least one additional tool for establishing financial behaviors that may enable the consumer to improve his or her credit worthiness. The tool(s) of the second level may be offered to a consumer when he or she has used the first level tool(s) to establish his or her financial behavior is sound, and enables a potential lender to determine whether or not the level of risk that would be assumed in extending credit to that consumer is acceptable. The second level may include a secured credit component. If so, the secured credit component may be embodied as any of a number of different means for providing consumers with secured credit, including, without limitation, simple secured credit cards, conventional multi-use accounts, which are also referred to as “multi-purpose accounts” and “fused accounts,” that include both debit and credit components and multi-use systems that are configured to provide consumers with even greater flexibility and control over the availability of funds in the debit and credit components of a multi-use account. By adding a secured credit component to a debit component, the second level of a system for establishing or improving a consumer's credit provides an opportunity for a consumer to establish some credit behavior and, thus, provides the consumer with further opportunities to develop and establish sound financial behaviors (or not). Potential lenders may consider this additional information about a consumer's financial behavior and/or credit behavior in deciding whether to extend credit to that consumer.

At a third level, a consumer may receive unsecured credit. A potential lender's willingness to extend unsecured credit to a consumer may be based on that consumer's financial behavior with the tool(s) provided at the first level and/or that consumer's credit behavior and any other financial behavior with the tool(s) provided at the second level. The amount of unsecured credit available to the consumer at the third level may be based on the consumer's prior financial behavior (which may include credit behavior). The amount unsecured credit available to the consumer at the third level may be varied on the basis of the consumer's continued financial behavior. In addition to providing potential lenders with even more information about the consumer's credit behavior and other financial behavior, the third level provides credit bureaus with the type of information they have conventionally considered in setting a consumer's credit score. Thus, the tool(s) that are available to the consumer at the third level may enable him or her to improve his or her credit score and seek and obtain credit from sources outside of the system.

In addition to three or more components or levels that provide a consumer with tools to establish his or her financial behavior and, thus, to establish or improve his or her credit worthiness, a system that incorporates elements of this disclosure may include an administrator. The administrator may collect and use or disseminate data that may be indicative of a consumer's financial behavior, including his or her financial behavior. In some embodiments, the administrator may simply collect, process and disseminate such data. In other embodiments, the administrator may administer one or more levels of the system. In some embodiments, the administrator may manage all of the levels of the system. The various functions of the administrator may be carried out by a single entity, or by a group of entities (e.g., an entity that generates an indicator of a consumer's credit worthiness, an entity that determine which level(s) a consumer may access, one or more entities that provide tools to the consumer, etc.).

In another aspect, techniques for obtaining and analyzing information indicative of a consumer's credit worthiness are disclosed. A variety of financial behaviors may be collected and analyzed, including, but not limited to, a consumer's behaviors that relate to spending, making payments, frequency and amounts of deposits and/or replenishments, and other financial activities. In situations where a consumer has little or no recent credit history, these financial behaviors may include little or no information about the consumer's credit behavior. When a consumer's financial behavior includes credit behavior, information about the consumer's credit behavior may be collected and analyzed.

Methods for enabling a consumer to establish or improve his or her credit worthiness based on his or her credit behavior or other financial behavior include the collection and analysis of such information. When a consumer's financial behaviors justify access to certain tools (e.g., the extension of secured credit, the extension of unsecured credit, etc.) and the consumer chooses to use those tools, additional data on the consumer's credit behaviors may be collected and analyzed. Sound financial behavior and credit behavior may enable a consumer to access even further tools (which may provide even more behavioral data) and, ultimately, enable the consumer to establish his or her credit worthiness and a credit score that will increase the availability of credit to the consumer.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 is a schematic representation of an embodiment of a system for enabling a consumer to establish or improve his or her credit worthiness;

FIG. 2 is a schematic representation of an embodiment of a multi-use financial account that includes interrelated debit and credit components;

FIG. 3 is a flow chart depicting various elements of a method for establishing, administering and using/managing a multi-use financial account such as that depicted by FIG. 2; and

FIGS. 4 through 18 illustrate various embodiments of the manner in which a multi-use financial account may be used by a cardholder to establish or reestablish his or her credit.

### DETAILED DESCRIPTION

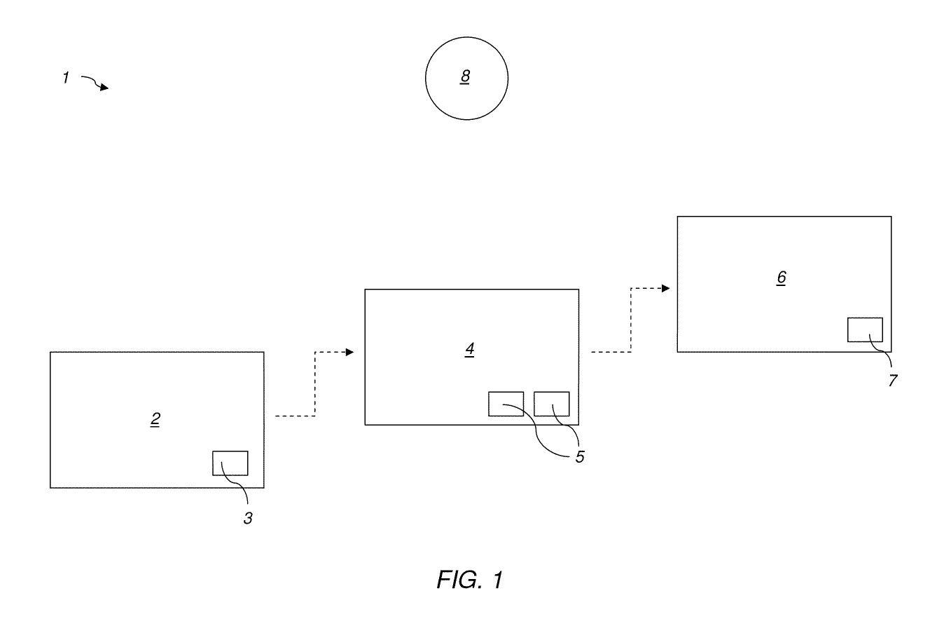

With reference to FIG. 1, an embodiment of a system 1 for enabling a consumer to establish or improve his or her credit is depicted. The system 1 includes a number of components, or levels 2, 4, 6. Each level 2, 4, 6 includes one or more tools 3, 5, 7, respectively. The tools 3, 5, 7 may comprise financial tools, such as transaction cards (e.g., debit cards, credit cards, etc.) and their associated accounts. Access to one or more levels 2, 4, 6 and, thus, access to the tool(s) 3, 5, 7 available at that level 2, 4, 6 may be granted to a consumer when the consumer meets certain predetermine criteria. In addition to various levels 2, 4, 6, a system 1 for enabling a consumer to establish or improve his or her credit may include an administrator 8.

The tools 3, 5, 7 available at each level may enable the a consumer to conduct certain financial activities. Depending upon how the consumer's conduct during those activities, he or she may establish a financial behavior that enables him or her to progress to another level 4, 6 and to use the tools 5, 7 that are available at that level.

At a first level 2 of system 1, a consumer may conduct basic financial transactions that require no credit worthiness or very little credit worthiness. Non-limiting examples of basic financial transactions include use of a general purpose reloadable (GPR) prepaid debit card, use of a debit cards associated with a deposit account (e.g., a checking account, a savings account, etc.), payment of periodic bills (e.g., rent, utility bills, mobile telephone bills, etc.) or the like.

To participate in the system 1, a consumer may provide the administrator 8 with access to records of the consumer's financial transactions. The financial transaction information to which the consumer grants the administrator 8 access may be complete (e.g., for a certain period of time, for certain types of financial transactions, etc.) and verifiable. In some embodiments, the consumer's participation in the system 1 may be contingent upon the consumer's management of all of his or her finances using a financial accounting system to which the administrator 8 has access (e.g., a financial accounting system hosted by the administrator 8, etc.) The financial transaction information obtained and analyzed, or considered, by the administrator 8 may include, consist essentially of, or even consist of financial transaction information that may be located and confirmed as corresponding to the consumer (e.g., by way of one or more of a Social Security Number, a driver's license number, another personal identifier, etc.).

In a specific embodiment, a consumer may begin participating in system 1 at the first level 2 by using a financial account—an embodiment of a tool 3 of the first level 2—that provides the administrator 8 with information about all of the consumer's attempted financial transactions and consummated financial transactions using that financial account. In specific embodiments, that financial account, or tool 3, may comprise a GPR prepaid debit card. In the United States of America, the Patriot Act only allows for the issuance of one GPR prepaid debit card at any point in time to each consumer, and requires that the consumer use his or her Social Security Number to obtain the GPR prepaid debit card. The GPR prepaid debit card may comprise a standard GPR prepaid debit card (e.g., a GREEN DOT® card, a BUY RIGHT™ card, an ONLY1 Prepaid VISA® card, etc.). Alternatively, the GPR prepaid debit card may be specific to the system 1 and, thus, it may be issued to a consumer who chooses to participate in the system 1. In some embodiments, the GPR prepaid debit card may be issued by the administrator 8. Alternatively, the GPR prepaid debit card may be issued by a card issuer whose financial products are used in the system 1. Of course, other arrangements may also be made to provide a consumer with a GPR prepaid debit card.

When the consumer completes or attempts to complete a financial transaction using the GPR prepaid debit card or any other tool 3 associated with the first level 2 of the system 1, the information about that transaction or attempted transaction may be transmitted to the administrator 8. That information may include information about the balance on the GPR prepaid debit card at the time each transaction is attempted, the amount of the attempted transaction (e.g., did the amount of an attempted transaction exceed the balance on the GPR prepaid debit card at the time the transaction was attempted? etc.), the amount(s) of money added to the balance, the frequency with which money is added to the balance, and the like.

Information obtained from the consumer's use of the GPR prepaid debit card may be used, alone or in combination with other financial information provided by the consumer to the administrator 8, to develop a profile of the consumer's financial behavior. That profile may be developed by scoring certain types of attempted and/or completed financial transactions, the values of those transactions and/or any weighting assigned to a particular type of financial transaction. Since the consumer's ability to initiate credit transactions at the first level 2 is limited (e.g., the consumer cannot initiate credit transactions at the first level 2, the credit transactions initiated by the consumer at the first level 2 are to payment of periodic bills, etc.), the profile of the consumer's financial behavior at the first level includes no credit behavior or very little credit behavior. In any event, with information about the consumer's basic financial transactions, and a profile of the consumer's financial behavior, the administrator 8 may be able to make a preliminary determination as to the consumer's credit worthiness. That preliminary determination may be in the form of an indicator, such as a classification, a score, or any other suitable indicator.

With a preliminary determination of a particular consumer's credit worthiness, the administrator 8 may be able to determine whether or not the consumer should be granted access to any of the subsequent levels 4, 6 of the system 1 and, thus, to the tools 5, 7 available at those levels 4, 6.

In the event that the administrator 8 grants a consumer with access to the second level 4, the consumer may have access to one or more tools 5 that enable the consumer to participate in a slightly more advanced level of financial transactions than those that are available to consumers who participate in the first level 2, which transactions are referred to herein as “intermediate financial transactions.”

Examples of tools 5 that enable a consumer to make intermediate financial transactions include, but are not limited to, basic secured credit accounts and, optionally, the cards that enable a consumer to consummate point of sale (POS) transactions with secured credit accounts. A secured credit account may be embodied as any of a number of different means for providing consumers with secured credit, including, without limitation, simple secured credit cards, conventional multi-use accounts that include both debit and credit components and multi-use systems that are configured to provide consumers with even greater flexibility and control over the availability of funds in the debit and credit components of a multi-use account.

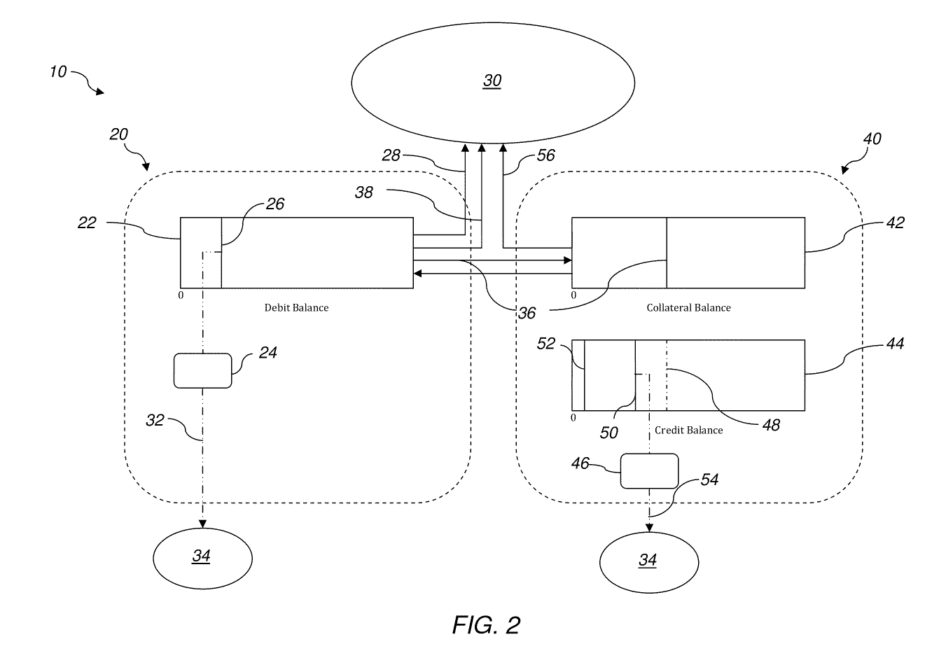

An embodiment of a multi-use account that may be used in a system 1 for enabling a consumer to establish or improve his or her credit worthiness is described in reference to FIGS. 2 through 18.Such a multi-use financial account includes a debit component and a credit component.

The debit component includes a debit account and an associated debit card. A consumer may be charged a fixed fee, or a debit account activation fee, when he or she opens the debit account to become a cardholder. In addition, the cardholder may incur fixed fees for various transactions, such as the use of automated teller machines (ATMs), point of sale (POS) transactions using the debit card and automatic bill pay services. These types of transactions may not be available through the credit component of the multi-use financial system. Instead, use of the credit component may be limited to simple credit card-based transactions.

The credit component of such a multi-use financial account may include a collateral account and a credit account. When a consumer chooses to benefit from the multi-use financial account, in addition to opening the debit account and receiving a debit card and a credit card, a collateral account and a credit account are also opened in the consumer's, or cardholder's, name. While the debit account is automatically activated, the cardholder may wait to activate the credit account. Activation of the credit account may include a transfer of funds from the debit account to the collateral account. In some embodiments, the credit account may not be activated until a minimum collateral amount, or minimum credit limit, is transferred from the debit account into the collateral account. With funds, or a collateral amount, deposited into the collateral account to provide the lender (e.g., the administrator of the multi-use financial account, etc.) with security for any amounts charged to the credit card, the cardholder may activate his or her credit card. Activation of the credit card may be accompanied by a credit account activation fee, which may be automatically charged against the credit account.

Once the credit card has been activated, the cardholder may begin using his or her credit card. The cardholder's use of his or her credit card is, of course, limited to the credit limit; i.e., the amount that has been deposited by the cardholder into his or her collateral account. At the end of each billing cycle, the cardholder will receive a bill with a payment due date. Interest may be charged against any credit balance that remains owing against the credit account on the payment due date, or following any grace period thereafter. The accrual of interest may further increase the credit balance. In some embodiments, a minimum payment against the credit balance may be automatically transferred from the debit account and applied to the credit account, without affecting the balance of the collateral account. While automatic payments may protect a cardholder against any damage to his or her credit worthiness, the cardholder may, in some embodiments, be enabled to opt out of automatic payments.

If the balance of the debit account is insufficient to make a minimum payment against the credit account, or if the cardholder does not make a required payment against the credit account, the lender may charge appropriate fees and, eventually, access funds from the cardholder's collateral account. Of course, nonpayment by the cardholder may also result in negative reports on the cardholder's credit worthiness (e.g., reports of nonpayment, reports of a reduction in the available credit limit as collateral for the credit limit is reduced, etc.).

Although a cardholder may have the option to access funds that have been deposited into the collateral account (e.g., by transferring those funds to the debit account or by otherwise withdrawing those funds from the collateral account), any effort to reduce the balance of the collateral account may be accompanied by a warning that doing so will reduce the cardholder's credit limit, and may have a negative effect on his or her credit worthiness.

In more detail, as depicted by FIG. 2, a multi-use financial account 10 may include a debit component 20 and a credit component 40. The debit component 20 and credit component 40 are interrelated in such a way that when a consumer decides to benefit from the multi-use financial account 10, the consumer is provided with access to both the debit component 20 and the credit component 40.

The debit component 20 of a multi-use financial account 10 includes a debit account 22 and a debit card 24 associated with the debit account 22. The debit account 22 comprises a financial account (e.g., a bank account, a checking account, etc.) configured to receive, and into which a consumer, who has become a cardholder, may deposit, funds. Funds may be deposited into the debit account 22 in any conventional manner (e.g., by depositing cash or checks, by direct deposit, by electronic funds transfer (EFT), etc.). The funds that have been deposited into the debit account 22 are also referred to herein as a “debit balance 26.”

In the context of a multi-use financial account that incorporates teachings of this disclosure, the debit account 22 and, thus, the debit balance 26 may be configured to serve a variety of functions. Among those functions are providing a balance from which a debit account activation fee 28 may be withdrawn and paid to a multi-use account multi-use account administrator 30 (e.g., a card issuer, another lender or financial institution, etc.). When the cardholder uses the debit card 24 to consummate a debit transaction 32 with a payee 34 (e.g., a retailer, a service provider, etc.), funds are be deducted, or debited, from the debit balance 26 and transferred to and deposited into an account associated with that payee 34. The cardholder may also use the debit card 24 to obtain cash (e.g., by way of an automated teller machine (ATM), from a bank, etc.) from his or her debit account 22. In addition, when the cardholder chooses to use the credit component 40 of the multi-use financial account 10, he or she may transfer funds, which serve as collateral 36 from debit account 22 to the credit component 40; those funds are, of course, deducted from the debit balance 26. Furthermore, the debit balance 26 may be used by the cardholder to make payments 38 to a multi-use account multi-use account administrator 30 for any credit balances, interest and/or fees accrued by the cardholder.

The debit card 24 may operate in any acceptable manner. In a specific embodiment, the debit card 24 comprises a pre-paid debit card, which limits debit transactions 32 to those with amounts that do not exceed the then-current debit balance 26 of the debit account 22 to which the debit card 24 corresponds. By limiting debit transactions 32 in this manner, the cardholder may avoid overdraft charges and the multi-use account multi-use account administrator 30 may avoid the risk associated with enabling a cardholder to use the debit card 24 to spend more than he or she currently has. Of course, the debit component 20 of a multi-use financial account 10 may also include other embodiments of debit accounts 22, including, but not limited to, checking accounts, savings accounts and the like.

The credit component 40 of the depicted multi-use financial account 10 includes a collateral account 42, a credit account 44 and a credit card 46 associated with the credit account 44. Although a cardholder may immediately begin using the credit component 40 upon enrolling in the multi-use financial account 10 and depositing funds into the debit account 22, the cardholder may also choose to delay usage of the credit component 40.

As soon as the cardholder decides to begin using the credit component 40, he or she may deposit funds into the collateral account 42. The collateral account 42 is a financial account that is configured to receive, and into which the cardholder may deposit, the collateral 36. As illustrated by FIG. 2, the collateral 36 may be transferred into the collateral account 42 from the debit account 22, or deposited into the collateral account 42 in any other acceptable manner known in the art. The collateral 36 that has been deposited into the collateral account 42 provides security for any charges made with the credit card 46 to the credit account 44. The multi-use account multi-use account administrator 30 may have a secured interest in the collateral 36. The balance of the collateral account 42, or the amount of the collateral 36 that has been deposited into the collateral account 42, serves as a credit limit 48 for the credit account 44.

In addition to being configured to receive funds, funds may be withdrawn from the collateral account 42. As the removal of any funds from the collateral account 42 will decrease the collateral 36 balance of that account and, thus, the credit limit 48 on the credit account 44, prior to allowing the funds to be withdrawn or transferred from the collateral account 42, the credit component 40 of the multi-use financial account 10 may be configured to warn the cardholder that he or she places his or her credit worthiness (e.g., credit rating, etc.) at further risk of reduction by removing the funds from the collateral account 42. A cardholder's ability to remove funds from the collateral account 42 and, thus, to reduce the balance of the collateral 36, may be limited by a balance due 50 on the credit account 44; i.e., the amount of collateral 36 in the collateral account 42 may not be reduced below the balance due 50 on the credit account 44. By limiting reduction of the collateral 36 amount in this manner, the risk to which the multi-use account multi-use account administrator 30 is exposed may be limited.

Once the cardholder has deposited collateral 36 into the collateral account 42, the credit component 40 of the cardholder's multi-use financial account 10 may be activated. In some embodiments, a minimum amount of collateral 36 may be required before the credit component 40 may be activated. Activation of the cardholder's credit card 46 may be automatic upon placement of sufficient collateral 36 in the collateral account 42, which may occur with a single deposit or be accrued over two or more deposits. Alternatively, the cardholder may be required to activate his or her credit card 46 and, thus, his or her ability to use the credit account 44. Such activation may be effected be telephone, text message, over the internet, or in any other suitable manner. Upon activating the credit component 40, including its credit card 46, a credit account activation fee 56 may be charged to the credit account 44, creating an initial balance due 50 and, thus, reducing the credit available against the credit limit 48 by an amount equal to the credit account activation fee.

With an active credit card 46, the cardholder may start using the credit card 46 to make purchases (each, a credit transaction 54 with a payee 34), thus increasing the balance of the cardholder's credit account 44. The credit card 46 may be used in the manner of a conventional credit card; i.e., the funds that correspond to each credit transaction 54 may be transferred from a lender, which may be the multi-use account administrator 30 or any other party who funds the cardholder's credit transactions through the multi-use financial account 10, to the payee 34. Each credit transaction 54 increases the balance due 50 on the cardholder's credit account 44.

Once the cardholder's balance due 50 reaches the credit limit 48 for the credit account 44, and while the balance due 50 is equal to or exceeds the credit limit 48, any transactions the cardholder attempts to complete with the credit card 46 may be denied. Moreover, a cardholder's ability to withdraw funds from the collateral account 42 may be limited to an amount that prevents the collateral 38 balance from falling beneath the balance due 50. When one or more of these types of features are coupled with limitations on the cardholder's ability to decrease the amount of collateral 36 in the collateral account 42, the multi-use account administrator 30 may limit its risk exposure to accrued interest and fees, and not to the amount of any transaction that has been consummated by the cardholder with the credit card 46.

At the end of each billing cycle, a bill may be transmitted (e.g., mailed, e-mailed, etc.) to the cardholder. The bill may provide a variety of information, including, without limitation, the charges that have been made against the credit account 44 during the billing cycle, any fees and interest charges that have been incurred during the billing cycle, any payments made during the billing cycle, the balance due 50 at the close of the billing cycle, the minimum payment due 52 and the due date for making the minimum payment. In some embodiments, the multi-use financial account 10 may be programmed to automatically transfer a predetermined amount (e.g., the minimum payment, balance due 50 at the end of the billing cycle, a fixed amount, etc.) from the debit account 22 to the credit account 44 on or before the due date, provided that the debit balance 26 is the same as or greater than the predetermined amount. In a more specific embodiment, a cardholder's multi-use financial account 10 may be programmed to automatically determine (e.g., in a prioritized fashion, such as the full balance due 50, the minimum payment, an amount equal to the debit balance 26, etc.) the amount to be automatically transferred from the debit account 22 to the multi-use account administrator 30 to reduce the balance due 50. In addition to any partial payments made by automatic transfers from the deposit account 22 to the multi-use account administrator 30, the cardholder may elect to make additional payments to the multi-use account administrator 30 to further reduce the balance due 50. In other embodiments, no payments may be made to the multi-use account administrator 30 until the cardholder authorizes the transfer of funds from the deposit account 22 to the multi-use account administrator 30 or otherwise pays the multi-use account administrator 30. Repeated use of the credit card 46 and regular payments that comply with the terms of the multi-use financial account 10 may be reported to one or more credit agencies, and may have a positive effect on a cardholder's credit rating.

In the event that the full minimum payment is not made by the due date, or at the end of a grace period following the due date, the multi-use account administrator 30 may charge a late fee to the credit account 44, deduct from the collateral account 42 (thus reducing the amount of the collateral 48) the difference between any payment made and the minimum payment, and/or provide the cardholder with notification that he or she has failed to comply with the payment terms of the multi-use financial account 10. In addition, the multi-use account administrator 30 may provide a negative report as to the cardholder's credit worthiness.

Several aspects of methods are apparent from the foregoing, including, but not limited to, methods from the perspective of a multi-use account administrator 30 (e.g., a lender, etc.) and methods from the perspective of a cardholder. From a multi-use account administrator 30′s perspective, a multi-use financial account 10 that incorporates teachings of this disclosure enables methods for providing credit to consumers and methods for enabling consumers to establish or reestablish their credit worthiness. Additionally, a consumer may use a multi-use financial account 10 to establish or reestablish his or her credit worthiness.

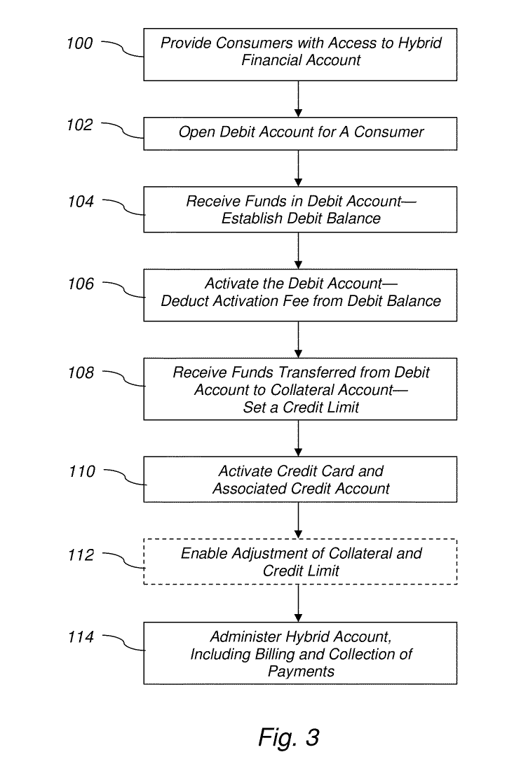

FIG. 3 is a flow chart illustrating elements of various methods for obtaining credit. Such methods are described with added reference to features of the system, or multi-use financial account 10, illustrated by FIG. 2. At reference 100 of FIG. 3, a multi-use account administrator 30 may provide consumers with access to a multi-use financial account 10. As part of the multi-use financial account 10, the multi-use account administrator 30 may, at reference 102 of FIG. 3, open a debit account 22 for the consumer. The consumer may open the multi-use financial account 10 in a number of different ways, such as in person, over the internet, by telephone, or in any other suitable way. While opening the multi-use financial account 10, the consumer may provide an account multi-use account administrator 30 with personal information. Once the consumer becomes a cardholder, he or she may receive from the multi-use account administrator 30 a debit card 24 and a credit card 46, along with access to a variety of administrative tools, such as the ability to access information from the cardholder's multi-use financial account 10 over the internet, by text message, over the telephone, or in any other suitable manner.

While opening the multi-use financial account 10, the new cardholder may, at reference 104 of FIG. 3, deposit funds into the debit account 22. Once funds have been deposited into the debit account 22, the multi-use account administrator 30 may, at reference 106 of FIG. 3, deduct a debit account activation fee from the debit balance 26 and provide the cardholder with a debit card 24. With his or her debit account 22 and debit card 24 activated, the cardholder may begin using his or her debit card 24 for to consummate transactions (e.g., obtain cash, make purchases, etc.).

The cardholder may, at his or her own election and at reference 108 of FIG. 3, transfer funds from the debit account 22 to a collateral account 42 of the multi-use financial account 10. Transferring funds to the collateral account 42, or otherwise increasing a balance of the collateral 38, may likewise set or increase a credit limit 48 for a credit account 44 of the multi-use financial account 10, as shown at reference 110 of FIG. 3. In addition to setting or resetting the credit limit 48, the cardholder may, at reference 112 of FIG. 3, activate a credit card 46 associated with the credit account 44. With the credit card 46 activated, the cardholder may begin using the credit card 46. The multi-use account administrator 30 may also begin billing the cardholder and receiving payments for the cardholder's use of the credit card 46, at reference 114 of FIG. 3, as part of the administration of the multi-use financial account 10. Further details on the use and administration of the credit component 40 have been provided previously herein.

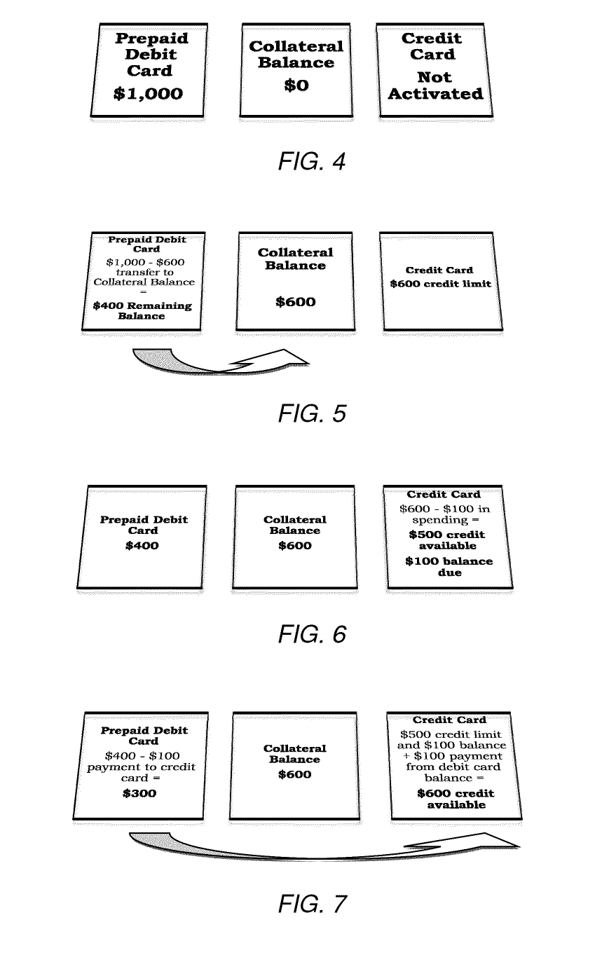

FIGS. 4 through 18 schematically depict various embodiments of the manner in which a consumer may obtain and begin using a multi-use financial account. In describing the subject matter depicted in FIGS. 4 through 18, reference is also made to FIG. 2 (particularly to the elements and reference characters shown in FIG. 2).

FIGS. 4 through 7 provide a simplified example, without fees or interest, of an embodiment of the manner in which a cardholder may use a multi-use financial account 10. In FIG. 4, once the cardholder has opened the multi-use financial account 10, he or she may make an initial deposit into its debit account 22. Specifically, in the embodiment depicted by FIG. 4, the initial deposit amounts to one thousand dollars (US $1,000).

In FIG. 5, the cardholder authorizes a transfer of funds from the debit account 22 to the collateral account 42 of his or her multi-use financial account 10. As illustrated, this transfer provides collateral 36 for the credit component 40 of the multi-use financial account 10, and provides the cardholder with an initial credit limit 48. In the illustrated example, six hundred dollars (US $600) is transferred from the debit account 22 to the collateral account 42, which sets the credit limit 48 for the cardholder's credit account 44 at six hundred dollars (US $600), leaving a debit balance 26 of four hundred dollars (US $400).

With the credit card 46 activated and a credit limit 48 on the credit account 44, the cardholder may begin using his or her credit card 46. As illustrated by FIG. 6, any transactions that are made using the credit card 46 increase the balance of the credit account 44, reducing the credit that remains available to the cardholder. In the example depicted by FIG. 6, the cardholder has used the credit card 46 to charge one hundred dollars (US $100) to the credit account 44, reducing the amount of available credit to five hundred dollars (US $500).

As shown in FIG. 7, the cardholder may pay all or part of the balance due 50 of his or her credit account 44 on or before the date on which a payment is due (e.g., before the end of a billing cycle in which a payment is due, etc.). That payment may be made in any suitable manner. In the embodiment depicted by FIG. 7, the payment is made by transferring funds from the debit account 22 to the multi-use account administrator 30. As illustrated, the amount transferred is one hundred dollars (US $100), reducing the balance of the debit account to three hundred dollars (US $300) and increasing the amount of available credit to six hundred dollars (US $600).

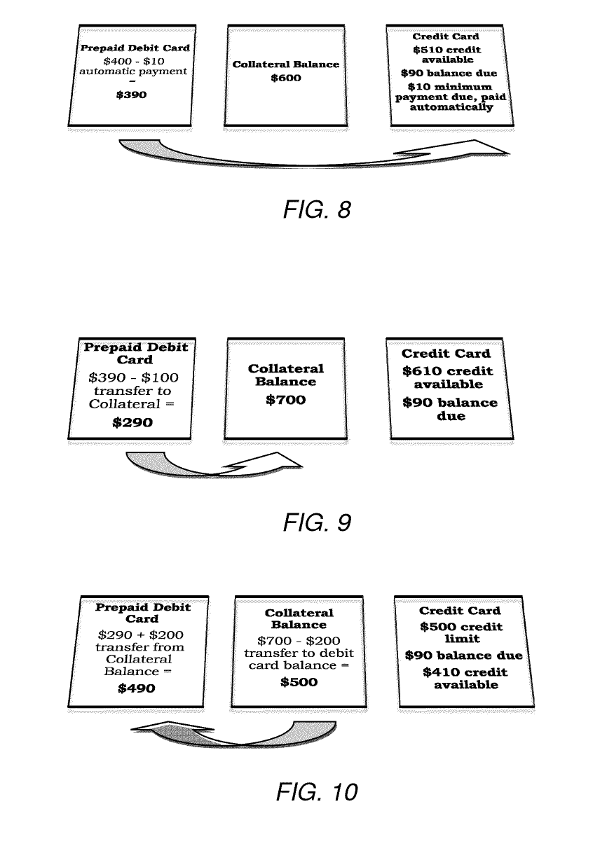

Alternatively, as depicted by FIG. 8, an automatic payment may be made. In some embodiments, an automatic payment may be made if no other payment is made before or on the due date. The automatic payment may be any predetermined amount. In some embodiments, the automatic payment may be equal to the minimum payment 54. In the illustrated example, the minimum payment 54 and, thus, the amount of the automatic transfer are ten dollars (US $10), reducing the balance of the debit account to three hundred ninety dollars (US $390) and increasing the amount of available credit to five hundred ten dollars (US $510), with a balance of ninety dollars (US $90) due on the credit account 44.

Continuing with the example provided by FIG. 8, FIG. 9 depicts a situation in which a cardholder chooses to increase the collateral 36 he or she has applied against the credit account 44 and, thus, the credit limit 48 for that credit account 44 and its associated credit card 46. The cardholder may initiate another transfer of funds from his or her debit account 22 to his or her collateral account 42, thereby increasing the amount of the collateral 36 for the credit account 44. In the illustrated example, the amount transferred is one hundred dollars (US $100), which decreases the debit balance to two hundred ninety dollars (US $290) and increases the balance of the collateral account 42 and, thus, the amount of the collateral 36 and the credit limit 48 on the credit account 44 to seven hundred dollars (US $700).

Conversely, as shown in FIG. 10, the cardholder may transfer funds from his or her collateral account 42 to his or her debit account 22. When such a transfer is made, the amount of the collateral 36 and, thus, the credit limit 48 on the credit account 44 is reduced. In the illustrated example, the cardholder has authorized the transfer of two hundred dollars (US $200) from the collateral account 42 to the debit account 22, decreasing the amount of his or her collateral to five hundred dollars (US $500) and increasing the debit balance 26 to four hundred ninety dollars (US $490). Such a transfer may not reduce the amount of the collateral 36 below the balance due 50; any effort to transfer funds in an amount that would decrease the amount of the collateral 36 below the current balance due 50 may be automatically prevented. Since any reduction in the cardholder's credit limit 48 may be perceived as a negative and, therefore, have a negative effect on the cardholder's credit worthiness, any effort by the cardholder to transfer funds from his or her collateral account 42 to his or her debit account 22 may be followed, and any transfer preceded, by an automatic warning or notification.

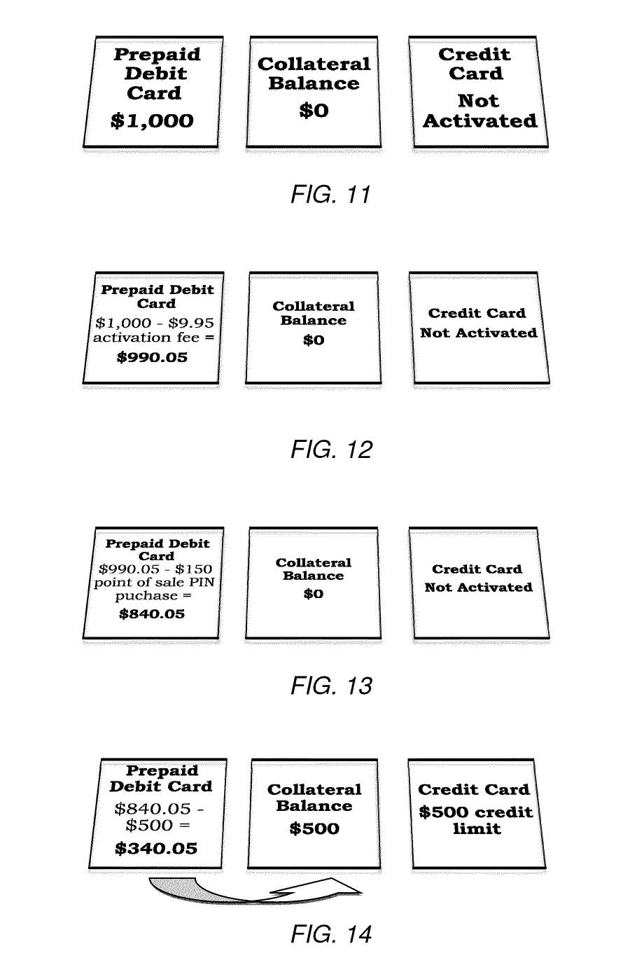

Referring now to FIGS. 11 through 18, embodiments of processes for activating and using a multi-use financial account 10 are depicted. In addition to illustrating various transactions and transfers that a cardholder may make, some of the fees and finance charges that the cardholder may incur are also shown.

In FIG. 11, once the cardholder has opened the multi-use financial account 10, he or she may make an initial deposit into its debit account 22. Specifically, in the example depicted by FIG. 11, the initial deposit amounts to one thousand dollars (US $1,000).

Upon making the initial deposit or activating the debit card 24 associated with the debit account 22, as shown in FIG. 12, a debit account activation fee 28 may be deducted from the debit account 22 and transferred to the multi-use account administrator 30. In the depicted example, the debit account activation fee 28 is nine dollars and ninety-five cents (US $9.95), reducing the debit balance 26 to nine hundred ninety dollars and five cents (US $990.05).

The cardholder may then use his or her debit card 24 to obtain cash or make purchases. With each debit transaction 32, the debit balance 26 of the debit account 22 is reduced. In FIG. 13, an example is shown in which the cardholder uses his or her debit card 24 to make a one hundred fifty dollar (US 150) POS purchase, reducing the debit balance 26 to eight hundred forty dollars and five cents (US $840.05). In some embodiments, transaction fees (e.g., ATM fees, POS fees, etc.) may also charged and deducted from the debit balance 26.

As depicted by FIG. 14, when the cardholder decides to begin using his or her credit card 46, the cardholder may transfer funds (i.e., collateral 36) from his or her debit account 22 to his or her collateral account 42, establishing a credit limit 48 for the associated credit account 44. In the example illustrated by FIG. 14, five hundred dollars (US $500) are transferred from the debit account 22 to the collateral account 42, decreasing the debit balance 26 to three hundred forty dollars and five cents (US $340.05) and establishing a credit limit of five hundred dollars (US $500).

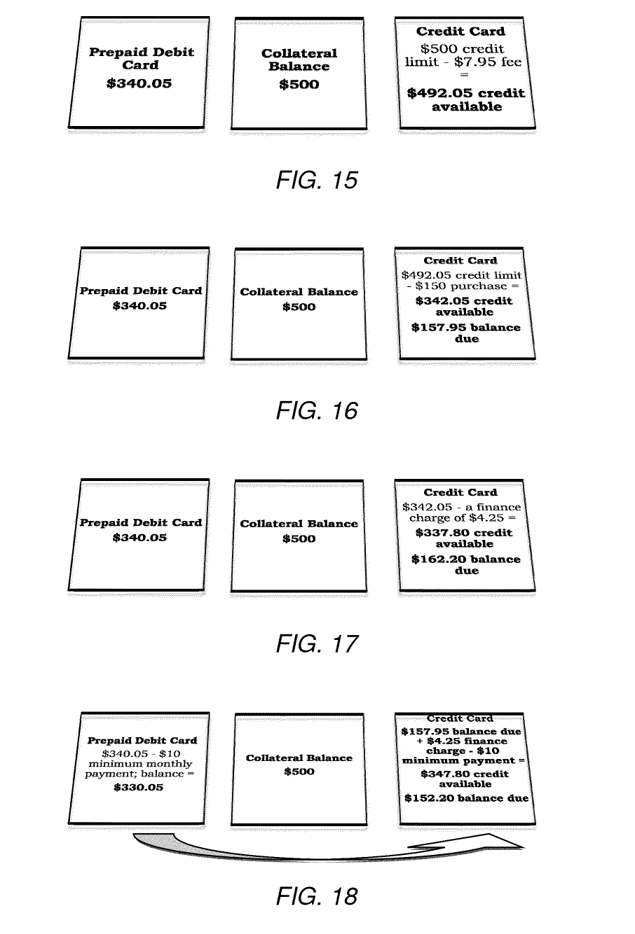

Once a cardholder has provided security, in the form of collateral 36, for use of the credit card 46 by depositing the collateral 36 into the collateral account 42, the multi-use account administrator 30 may charge the cardholder a credit account activation fee 56, as shown in FIG. 15. Specifically, FIG. 15 illustrates an example in which a charge of seven dollars and ninety-five cents (US $7.95) is added to the balance due 50 of the cardholder's credit account 44, decreasing the amount of credit available to the cardholder to four hundred ninety-two dollars and five cents (US $492.05).

With the credit card 46 activated, the cardholder may begin using it to consummate financial transactions. FIG. 16 illustrates an example in which the cardholder has made one hundred fifty dollars (US $150) in purchases with his or her credit card 46. As a result, the previous balance of four hundred ninety-two dollars and five cents (US $492.05) of available credit has been reduced to three hundred forty-two dollars and five cents (US $342.05).

In the event that the cardholder carries a balance due 50 for a sufficient period of time (e.g., beyond the close of a billing cycle, etc.) to trigger interest payments or other acceptable finance charges, those finance charges will also be added to the balance due 50 and, thus, deducted from the amount of credit available to the cardholder, as depicted by FIG. 17. Finance charges may be applied and accrued in an acceptable way (e.g., they may be accrued continuously or periodically (e.g., daily, monthly, etc.), etc.). In FIG. 17, an 18.9% annual rate finance charge, which accrues monthly, is charged against and added to a balance due 50 of one hundred fifty-seven dollars and ninety-five cents (US $157.95), etc.), leaving a balance due 50 of one hundred sixty-two dollars and twenty cents (US $162.20) and three hundred thirty-seven dollars and eighty cents (US $337.80) of credit available to the cardholder.

As shown in FIG. 18, the cardholder may be periodically billed for his or her use of the credit card 46. The cardholder may receive a billing statement that identifies a minimum required payment. In some embodiments, the minimum required payment may be the greater of a fixed amount (e.g., ten dollars (US $10), etc.) and a percentage (e.g., 4%, etc.) of the balance due 50. Continuing with the example depicted by FIG. 18, a balance due 50 of one hundred fifty-seven dollars and ninety-five cents (US $157.95), along with a finance charge of four dollars and ninety-five cents (US $4.95) may require a minimum payment of ten dollars (US $10), which, when paid, would leave a balance due 50 of one hundred fifty-two dollars ad twenty cents (US $152.20), with three hundred forty-seven dollars and eighty cents (US $347.80) of credit being available to the cardholder.

A multi-use financial account 10, which includes a debit card, a secured credit card, and corresponding accounts, may be marketed to consumers in a variety of ways. As one example, the multi-use financial account 10 may be marketed as a secured credit card with the added bonus of an associated prepaid debit card that allows cardholders to load the debit account 22 using cash or direct deposits. Such a multi-use financial account 10 may also be marketed as a system by which the cardholder sets his or her own credit limit. Moreover, the features of the multi-use financial account 10 that prevent late payments may be marketed to potential cardholders—the security provided by the collateral 36, automatic transfers from the debit account 22 to pay off (at least minimum) balances due 50 at the end of each billing cycle, etc. The multi-use financial account 10 may also be offered directly by retailers for use as a regular prepaid card with the additional benefit of the availability of a related secured credit card.

With returned reference to FIG. 1, information about the financial transactions that a consumer attempts to make and in which a consumer participates at the second level 4 of the system 1 may provide the administrator 8 with additional information, including some of the consumer's credit behavior, to be considered by the administrator 8 in determining consumer's credit worthiness. That additional information may provide the administrator 50 with a better understanding of the consumer's credit worthiness and, thus, may be considered by the administrator 8 in adjusting the indicator (e.g., score, classification, etc.) of the consumer's credit worthiness.

With continued reference to FIG. 1, when a consumer exhibits sound financial behavior at one or both of the first level 2 and the second level 4 of system 1, the administrator 8 may provide the consumer with access to a third level 6 of the system 1, along with the tool(s) 7 that are available at the third level 6. The tool(s) 7 available at the third level 6 may include financial tools that provide a consumer with at least a basic level of unsecured credit, thereby enabling the consumer to participate in an even further level of financial transactions.

In some embodiments, as a consumer's credit worthiness at the second level 4 improves, the administrator 8 or an entity that provides the consumer with secured credit may provide the consumer with an option to receive a refund of, or even automatically refund, part of the secured portion of his or her credit limit. Thus, based on sound financial behavior at the second level 4, a consumer may transition to the third level 6 by receiving gradually increasing amounts of unsecured credit. In other embodiments, a consumer, upon gaining entry to the third level 6, may receive a new financial account (e.g., a credit card account, etc.) with an unsecured credit limit. In this disclosure, the further level of financial transactions available at the third level 6 are referred to as “advanced financial transactions.”

As a consumer makes advanced financial transactions, the consumer further establishes his or her financial behavior, including credit behavior. The consumer's credit behavior may be evaluated by the administrator 8 in deciding whether or not to adjust the amount of credit available to the consumer, and in deciding whether additional types of credit may be offered or extended to the consumer. In addition, any advanced financial transactions that the consumer makes using the tool(s) 7 made available to the consumer at the third level 6 may provide the type of information that the credit bureaus and traditional lenders consider in deciding whether to extend credit to consumers (e.g., the types of information considered in determining FICO scores, etc.). Thus, the tool(s) 7 that are available to the consumer at the third level 6 may enable him or her to improve his or her credit score and seek and obtain credit from sources outside of the system.

When the administrator 8 provides a consumer with access to a higher level 4, 6 of the system 1 and, thus, with the ability to assume more financial responsibility, the consumer may still use the tools 3, 5 associated with each lower level 2, 4 of the system 1. A consumer may periodically apply for access to a level 4, 6 of increased financial responsibility, or the administrator 8 may periodically determine the consumer's credit worthiness and, if appropriate, automatically provide the consumer with access to a level 4, 6 of increased financial responsibility.

From the foregoing, it should be apparent to those of ordinary skill in the art that a system 1 for enabling a consumer to establish or improve his or her credit worthiness bases a consumer's credit worthiness of a number of unconventional factors, including information about the consumer's basic financial transactions, the consumer's behavior in maintaining basic financial accounts, and other information about the consumer's finances. In some embodiments, a consumer who wants to participate in a system 1 that incorporates teachings of this disclosure may provide the administrator 8 of such a system with a holistic view of the consumer's financial accounts. In addition, traditional indicators of credit worthiness may be considered. Potential lenders may consider this additional information about a consumer's financial behavior and/or credit behavior in deciding whether to extend credit to that consumer.

The disclosed embodiments should not be deemed to limit the scope of any of the claims that follow. The scope of each claim should be limited merely by its plain language, and should be deemed to include the full complement of available equivalents.

What is claimed:

1. A system for enabling a consumer to establish or improve credit worthiness, comprising:
a first level at which a consumer receives at least one first financial tool that enables the consumer to conduct basic financial transactions;
a second level at which the consumer receives at least one second financial tool that enables the consumer to conduct intermediate financial transactions;
a third level at which the consumer receives at least one third financial tool that enables the consumer to conduct advanced financial transactions; and
an administrator that:
receives financial information about the consumer, including financial information not traditionally considered in determining a credit rating, the financial information comprising financial information about one or more of the basic financial transactions, the intermediate financial transactions and the advanced financial transactions;
evaluates the financial information; and
assigns an indicator of a credit worthiness of the consumer based on the financial information.

2. The system of claim 1, wherein the first financial tool comprises a financial tool for which all financial transactions are traceable and verifiable.

3. The system of claim 2, wherein the first financial tool comprises a general purpose reloadable(GPR) debit card.

4. The system of claim 1, wherein the second financial tool comprises a secured credit account.

5. The system of claim 4, wherein the secured credit account is part of a multi-use account that also includes a debit account.

6. The system of claim 1, wherein the third financial tool comprises an unsecured credit component.

7. The system of claim 6, wherein the unsecured credit component comprises an unsecured credit card.

8. The system of claim 1, wherein the administrator, based on the indicator of credit worthiness, selectively provides the consumer with access to one or more of the first level, the second level and the third level.

9. The system of claim 1, wherein the administrator issues one or more of the at least one first financial tool, the at least one second financial tool and the at least one third financial tool.

10. The system of claim 1, wherein the indicator of credit worthiness is based primarily on the financial information not traditionally considered in determining a credit rating.

11. The system of claim 1, wherein the indicator of credit worthiness is based on verifiable and complete financial information of the consumer.

12. The system of claim 11, wherein the administrator grants the consumer access to one or more of the first level upon receipt and verification of the verifiable and complete financial information.

13. A method for determining credit worthiness of a consumer, comprising:
receiving verifiable and complete financial information for the consumer, including the financial information not traditionally considered in determining a credit rating;
considering the verifiable and complete financial information; and
assigning an indicator of credit worthiness to the consumer based on the verifiable and complete financial information.

14. The method of claim 13, further comprising:
verifying a completeness of the verifiable and complete financial information.

15. The method of claim 13, further comprising:
collecting information on basic transactions attempted and conducted with a first financial tool;
considering the information on the basic transactions; and
reevaluating the indicator of credit worthiness based on the information on the basic transactions.

16. The method of claim 15, wherein collecting information comprises collecting information on basic transactions attempted and conducted with a debit card.

17. The method of claim 16, wherein collecting information comprises collecting information on basic transactions attempted and conducted with a general purpose reloadable debit card.

18. The method of claim 15, further comprising, after reevaluating the indicator of credit worthiness:
enabling the consumer to receive a second financial tool with which the consumer may conduct intermediate financial transactions;
collecting information on the intermediate financial transactions attempted and conducted with the second financial tool;
considering the information on the intermediate financial transactions; and
reevaluating the indicator of credit worthiness based on the information on the intermediate financial transactions.

19. The method of claim 18, wherein enabling the consumer to receive the second financial tool comprises enabling the consumer to receive a secured credit card.

21. The method of claim 19, wherein enabling the consumer to receive the second financial tool comprises enabling the consumer to open a multi-use account, of which the secured credit card is a component.

23. The method of claim 15, further comprising, after reevaluating the indicator of credit worthiness:
enabling the consumer to receive a third financial tool with which the consumer may conduct advanced financial transactions.

24. The method of claim 23, wherein enabling the consumer to receive the third financial tool comprises enabling the consumer to receive unsecured credit.

25. The method of claim 24, wherein enabling the consumer to receive unsecured credit comprises enabling the consumer to receive an unsecured credit card.

26. The method of claim 23, further comprising:
collecting information on the advanced financial transactions attempted and conducted with the third financial tool;
considering the information on the advanced financial transactions; and
reevaluating the indicator of credit worthiness based on the information on the advanced financial transactions.
